(19) United States
(12) Patent Application Publication
(10) Pub. No.: US 2025/0364567 A1
(43) Pub. Date: Nov. 27, 2025

(54) HIGH-PERFORMANCE LITHIUM BATTERY CURRENT COLLECTOR AND PREPARATION METHOD THEREFOR, AND CONDUCTIVE PASTE AND PREPARATION METHOD THEREFOR

(71) Applicants: BLUEGLOWNANO TECHNOLOGIES LIMITED, Dongchong Town (CN); GUANGZHOU NANO NEW MATERIAL TECHNOLOGY CO., LTD., Nancun Town (CN)

(72) Inventors: Qizhong LIAO, Dongchong Town (CN); Qingqing ZHANG, Dongchong Town (CN); Haochao LU, Dongchong Town (CN); Chen ZHANG, Dongchong Town (CN); Jie WU, Dongchong Town (CN)

(73) Assignees: BLUEGLOWNANO TECHNOLOGIES LIMITED, Dongchong Town (CN); GUANGZHOU NANO NEW MATERIAL TECHNOLOGY CO., LTD., Nancun Town (CN)

(21) Appl. No.: 18/873,207

(22) PCT Filed: Jul. 13, 2023
(86) PCT No.: PCT/CN2023/107196

§ 371 Date: Jun. 2, 2025

(30) Foreign Application Priority Data
May 9, 2023 (CN) 202310512566.1

(51) Int. Cl. H01M 4/66; H01M 4/75; H01M 10/052; H01M 10/058

(52) U.S. Cl. CPC H01M 4/663; H01M 4/661; H01M 4/667; H01M 4/75; H01M 10/058; H01M 10/052

(57) ABSTRACT

A high-performance lithium battery current collector and a conductive slurry, and preparation methods therefor. A functional coating of the current collector is a functional layered covering structure with a thickness of no more than 800 nm formed by coating a conductive slurry on a surface of a metal foil and drying. The functional coating includes a plurality of strip-shaped modified conductive agents, and after being cured and molded, the modified conductive agents are parallel to one another in the functional coating, axes of the modified conductive agents are arranged obliquely relative to a surface of the metal foil at an included angle of 15° to 45° within a thickness of the functional coating, and the modified conductive agents are interwoven with a modified nanofiber, a binder and the conductive agent in the coating.

### TECHNICAL FIELD

The disclosure belongs to the technical field of lithium battery production, and particularly relates to a high-performance lithium-ion battery current collector and a conductive slurry, and preparation methods therefor.

### BACKGROUND

With increasing market demand, traction lithium-ion batteries have been widely used in industrial fields such as new energy automobiles and large-scale energy storage. Current collectors of secondary batteries are designed to collect currents, and are in the form of a metal foil, such as a copper foil and an aluminum foil for the lithium-ion batteries. They also include tabs in a broad sense. The current collectors mainly work to collect currents generated by active materials of the battery and form a high one for external output. As a result, the current collectors are necessarily in full contact with the active materials with an internal resistance as small as possible.

In the prior art, it is a remarkably technological innovation to treat the surface of a conductive substrate of the battery with a functional coating. The carbon-coated aluminum foil/copper foil is obtained by evenly and finely coating well-dispersed conductive materials such as nano-conductive graphite, carbon coated particles and carbon nanotubes on the aluminum foil/copper foil. It can collect micro-currents of the active materials based on its excellent static conductivity, thus greatly reducing a contact resistance between a positive or negative material and the current collector, improving the fixation capacity between them, reducing a use amount of binders, and further significantly improving an overall performance of the battery.

At present, LiFePO₄ is a promising positive material due to its higher safety and cost performance. However, when applied, it is poor in conductivity and fixation (binding) and likely to shed powder due to its low electron and ion conductivity and low mass and tap densities. When applied to a positive current collector, the carbon-coated aluminum foil can reduce the interface contact impedance and the internal resistance of the battery, alleviate internal polarization of the battery, and improve a discharge rate of the battery to some extent. Aiming to the negative electrode, using the carbon-coated copper foil can provide a high-surface density and a high binding performance of an electrode foil of a high-energy density battery, and avoid powder shedding during punching of a stacked battery, even in a highly expandable silicon-carbon materials system.

The existing carbon-coated foil is made by compounding conductive materials of graphite, carbon black, multi-layer carbon nanotubes, etc. and coating a conductive slurry composed of dispersed evenly dispersants and binders in different proportions on the aluminum foil or the copper foil. A carbon-coated layer is thick within 2 μm to 50 μm, and the stripping resistance for repeated charging is poor. According to the compounding ratio of the conductive agent, the carbon-coated layer varies in appearance but is generally black or gray with different depths. However, when different lithium-ion battery material systems are used, the quality stability of the current collector products cannot be improved since a coating machine cannot determine a coating coverage rate and a coating thickness of the electrode foil by observing or monitoring, through machine vision, color or a color difference. As a result, the coating coverage rate cannot be monitored during high-speed production quality management, and improvement in production efficiency is limited accordingly.

In order to improve the performance of the conductive coating of the current collector in the prior art, disclosed in Chinese Invention Patent Application Number: 201610410998.1 are a carbon nanotube conductive coating current collector and a preparation process thereof. The carbon nanotube conductive coating current collector includes a metal current collector and a carbon nanotube conductive coating, and the carbon nanotube conductive coating is coated on a surface of the metal current collector. The carbon nanotube conductive coating has a thickness of 1 μm to 50 μm, and a surface thereof is provided with a network micro-crack structure and a rough porous structure. The carbon nanotube conductive coating of the disclosure provides a desirable conductive network for electrodes, and dense micro-cracks are formed on a dried surface of the carbon nanotube conductive coating by preparing a conductive slurry with different dispersion effects. In this way, force of bonding to the current collector is improved and an internal resistance of a battery is reduced. However, the conductive coating in this technical solution needs to use two or more conductive materials, and has a great thickness at a micron level. The conductive coating is likely to fall since its fixation (representing the durability of the coating) degrades quickly after numerous cycles of charging and discharging. As a result, a metal layer of the current collector is directly exposed to an active material, the electrodes of the current collector are corroded and oxidized and fail, and the battery life is further shortened. In addition, the conductive coating after coating of this material is poor in reset and appears black or gray, and the thickness and coverage rate of the coating cannot be determined according to the color and color difference of the coating during coating. Effective coating quality monitoring means lacks during the coating. Further, subsequent coating and welding of the electrode foil of the battery are adversely affected since the color of the coating cannot be accurately determined.

Disclosed by Chinese Invention Patent Application Number 201610522526.5 are a conductive slurry and a method for forming a network carbon thermal-conductivity and electrical-conductivity network current collector by using same. The conductive slurry is made from the following raw materials of, by weight, 4 to 6 parts of carbon nanotubes, 8 to 12 parts of conductive carbon black, 1 to 3 parts of flake graphite and 15 to 25 parts of polyvinyl acetate. According to the disclosure, one-dimensional or multi-dimensional carbon materials with high thermal conductivity and electrical conductivity can be used to form a network material. For example, high thermal-conductivity materials such as the carbon nanotubes and the graphene are added into general conductive carbon black to form a continuous thermal-conductivity and electrical-conductivity network coating on the current collector. In this way, the heat dissipation effect can be improved by charging and discharging at a high rate, the electrical conductivity demand is satisfied, and the service life of the system is prolonged by avoiding heat-induced aging. However, in the technical solution, the conductive network coating formed by two or more conductive materials is still thick, and poor in coating resetting and has an unmonitorable color of gray or black. In addition, its spatial structure of network materials is randomly distributed and non-oriented, which is unconducive to reduction in an internal resistance of the interface, and improvement in electrical conductivity, thermal conductivity and fixation.

During charging and discharging processes of the lithium battery, relative positions, contact surfaces and contact points between components (especially between the active material, the conductive material and the current collector) of internal substances change periodically based on electrochemical reaction and physical volume change. During the change process, especially in the process of size expansion, distances between components are expanded, contact points decrease and contact resistances increase, resulting in an increase in the internal resistance of the battery and rapid decline in efficiency. Moreover, after each cycle, it is difficult to ensure that all substances can be accurately reset and restored to an original connection network and strength, the spatial distribution of the components is gradually out of order, and the connection (electrical conductivity and thermal conductivity) performance deteriorates. As a result, various performances of the battery deteriorate after numerous cycles. In order to overcome this defect, it is necessary to maintain a strong connection network and strength between the components of the lithium battery during the charging and discharging processes and after numerous cycles. Hence, the problem that the loss of the connection network caused by physical and chemical effects result in an increase in internal resistance and a reduction in capacity of the battery is solved.

In the prior art, the randomly and irregularly arranged carbon nanotubes cannot give full play to excellent mechanical, and electrical-conductivity and thermal-conductivity performances of a single carbon nanotube and its array. In addition, the irregular arrangement is prone to lead to agglomeration of the carbon nanotubes and an increase in the contact resistance between the carbon nanotubes. As a result, the performance of the negative material of the lithium-ion battery made from such conductive coating materials is far lower than expected. However, a specific three-dimensional structural skeleton constructed by arranging the carbon nanotubes according to rules is uneasy to control and implement. In view of that, a comprehensive performance of the current collector can be merely improved by simultaneously improving preparation processes of the carbon nanotubes, the conductive slurry, the coating structure and the current collector.

### SUMMARY OF THE INVENTION

In order to solve the shortcomings of the prior art, the disclosure provides a high-performance lithium battery current collector. A functional coating of the high-performance lithium battery current collector adopts modified conductive agents as conductive materials, and based on a dumbbell-shaped structure of the modified conductive agent, a bridge-island structure that is anchored at both ends and can automatically adapt to and offset change and deformation of a size, etc. is formed in the coating. In addition, the modified conductive agents are arranged obliquely at a specific angle of 15° to 45° and in parallel in a thickness direction under the action of an external magnetic field, and form a three-dimensional network structure with enhanced fixation, electrical conductivity, thermal conductivity and high reset characteristics, so as to solve the problem that a network structure in the prior art is of an irregular arrangement and cannot give consideration to enhanced fixation, electrical conductivity and thermal conductivity of a coating at the same time. When applied to a lithium battery, the current collector of the disclosure can better establish a spatial network structure and reliably connect to active ingredients. During expansion and contraction of a battery coating and active materials caused by charging and discharging, the modified conductive agent can keep orderly spatial distribution of conductive materials in the lithium battery through its angle change and anchoring effect, thus keeping a connection network and an electrical connection strength stable, and solving the problems that in an application to the lithium battery in the prior art, a coating is likely to fall off due to rapid deterioration of fixation force after numerous charging and discharging cycles.

The disclosure further provides a method for preparing the modified conductive agent that has the dumbbell-shaped structure. According to the method, a multi-walled carbon nanotube is oxidized, both ends of the multi-walled carbon nanotube are chemically modified, the both ends are pre-connected to other conductive agent particles those have greater sizes to form the dumbbell-shaped structure, and a bridge-island structure that is anchored at both ends and can automatically adapt to a regular arrangement, automatically adjusts an oblique angle, and offset change and deformation of a size, etc. is formed in the coating. During oxidation, the carbon nanotube modified conductive agent have weak magnetism since a single layer of carbon nanotubes has a vacancy defect formed due to local C—C bonds being opened by oxidation, and magnetic moment is caused near the defect due to the defect.

The disclosure further provides a conductive slurry for preparing the functional coating and a preparation method therefor. By synchronously improving a formula and a preparation process of a coating, an addition amount of modified conductive agents is reduced, and an average thickness of a dried coating is not greater than 800 nanometers. The modified conductive agents of weak magnetism are used to form a structure that is obliquely arranged at a specific angle of 15° to 45° in a thickness direction in the coating, a specific surface area of the coating in contact with active materials is further expanded, fixation force of the coating after numerous charge and discharge cycles is greatly enhanced, the problems of a great thickness, poor fixation force, etc. of an existing coating is solved, and prolonging of a service life and an improvement in high-rate performance of secondary batteries such as the lithium ion battery are achieved.

The disclosure further provides a method for preparing the current collector. Thus, the problem that an adaptive three-dimensional network connection structure is difficult to form in a coating through a complex process is solved, a magnetically-oriented modified conductive agent array is achieved through a constant magnetic field, a conductive performance and fixation force of the functional coating are enhanced, and a use amount of modified conductive agents and a thickness of the functional coating are reduced. In a process of coating a conductive slurry, a three-dimensional structure of the modified conductive agents and a substrate is molded, and easy to shape and control. The structural molding can be completed simultaneously during the coating and drying, processes can be saved, and a coating structure composed of the oriented modified conductive agents and the substrate that are interwoven can be obtained.

In order to achieve the above objective, the disclosure provides the following technical solution:

A high-performance lithium battery current collector includes a metal foil and a functional coating. The functional coating is a functional layered covering structure with a thickness of no more than 800 nm formed by coating a conductive slurry on one or both surfaces of the metal foil and drying. The functional coating includes a plurality of strip-shaped modified conductive agents, and the modified conductive agent is a magnetically-oriented modified multi-walled carbon nanotube. After being cured and molded, the modified conductive agents are parallel to one another in the functional coating, axes of the modified conductive agents are arranged obliquely relative to a surface of the metal foil at an included angle of 15° to 45° within a thickness of the functional coating, and the modified conductive agents are interwoven with a modified nanofiber, a binder and the conductive agent in the coating, so as to form an oriented three-dimensional network connection structure with enhanced fixation, electrical conductivity and thermal conductivity, and uniform deformation and resetting.

The magnetically-oriented modified multi-walled carbon nanotubes in the functional coating are modified multi-walled carbon nanotubes with a dumbbell-shaped structure whose inner diameter is not less than 5 nm, outer diameter is not greater than 20 nm, and length is not greater than 1200 nm. After being oxidized and chemically modified, the modified multi-walled carbon nanotubes have a dumbbell-shaped fiber structure with two thicker ends and a thinner middle, and thicker lower ends are respectively connected to the surface of the metal foil and upper ends are connected to one another after an orientation arrangement of the modified multi-walled carbon nanotubes. Other conductive agent particles with different sizes and the modified nanofiber are sandwiched in a thinner fiber part in the middle under the action of cooperation of a binder, such that all parts are connected to one another to form a three-dimensional network with a bridge-island structure that has both ends anchored and is of the orientation arrangement. An elastic three-dimensional network limits deformation and displacement of the modified multi-walled carbon nanotubes and the conductive agent particles during a work process of a battery, so as to automatically adapt to and offset an internal volume change, and the deformation and the displacement of the conductive particles during charging and discharging processes of the lithium battery, and maintain reliability of the functional coating for a connection between the surface of the metal foil and an active material.

A conductive slurry for preparing the high-performance lithium battery current collector is provided. The conductive slurry is an aqueous slurry prepared by dispersing and mixing a modified multi-walled carbon nanotube, a nano-conductive agent, a modified nanofiber, a dispersant, a binder and a solvent, and the slurry has a solid content of 0.1% to 5%, a viscosity of 200 mPa·s to 1000 mPa·s at 25° C., and a pH of 8 to 11.

A weight ratio of raw material components of the conductive slurry is as follows: the modified multi-walled carbon nanotube:the nano-conductive agent:the modified nanofiber:the dispersant:the binder:the solvent=(0.01-1.8):(0.01-0.2):(0.02-2):(0.02-20): (0.05-20):(56-99.89).

A method for preparing the conductive slurry for preparing the high-performance lithium battery current collector includes:
S1, preparing materials: preparing a modified multi-walled carbon nanotube, a nano-conductive agent, a modified nanofiber, a dispersant, a binder and a solvent in proportion;
S2, preparing a high-concentration modified conductive agent suspension: weighing the modified nanofiber and the dispersant in proportion and adding them into ⅓ of the solvent, and completely dissolving the modified nanofiber and the dispersant through mechanical stirring; weighing and adding a modified conductive agent of an amount required into a mixed solution, and performing ultrasonic treatment for 30 min; and obtaining a modified conductive agent suspension, specifically a modified multi-walled carbon nanotube suspension;
S3, performing magnetizing: placing a modified multi-walled carbon nanotube and nano-conductive agent dispersion solution in a strong external magnetic field for magnetization to further stimulate the magnetic anisotropy of magnetically-modified multi-walled carbon nanotubes to obtain a the high-concentration magnetically-modified multi-walled carbon nanotube suspension;
S4, performing preliminary dispersion: adding a binder in a corresponding proportion to the high-concentration magnetically-modified multi-walled carbon nanotube suspension, supplementing the solvent to a required amount, and performing the preliminary dispersion by sequentially using a high-speed vacuum disperser and a sand mill; where the vacuum disperser has a shearing speed of 10 m/s to 25 m/s, a vacuum degree not lower than 0.085 MPa, and vacuum dispersing time of 1 h to 5 h during dispersion, and the sand mill includes sand mill beads that have a diameter of 0.2 mm to 2 mm and account for 30% to 90%, and has a sand mill speed of 600 r/min to 10000 r/min and sand mill time of is 0.1 h to 5 h; and
S5: performing secondary dispersion: performing the secondary dispersion using an ultrasonic processing apparatus in an ultrasonic resonance manner, applying alternating magnetic fields at two sides to further uniformly disperse the modified multi-walled carbon nanotubes and nano-conductive agent particles and align them in the same direction under induction of the magnetic field, and preparing the magnetically-oriented conductive slurry.

A method for preparing the high-performance lithium battery current collector includes:
(A1) preparing a metal foil of the current collector and a dispersed conductive slurry, and arranging a coating apparatus, an ultrasonic apparatus, a constant magnetic field generator, and a drying device;
(A2) coating the dispersed conductive slurry on a surface of the metal foil, and forming a liquid colloid coating that has a viscosity of 200 mPa·s to 1000 mPa·s at 25° C. and a thickness of 500 nm to 1200 nm on the surface;
(A3) continuously applying a constant magnetic field that has a direction perpendicular to the surface of the metal foil to the liquid colloid coating, and causing, under induction of the external magnetic field, oriented modified conductive agents in the coating to be orderly arranged, gradually straightened from an original winding state, in a parallel arrangement array, and interwoven with a substrate; and
(A4) drying the coating, evaporating a solvent and a volatile component, continuously applying a constant magnetic field, causing the modified conductive agents to keep an arrangement position and posture, and to be quickly set along with a rapid increase in a viscosity of the coating, and to be arranged obliquely at an angle of 15° to 45° and in parallel in a thickness direction until a solidifiable component of the coating conductive slurry is fixed to the surface of the metal foil, and forms a dense functional covering structure that has a thickness not less than 800 nm, that is, a three-dimensional network connection structure with enhanced fixation, electrical conductivity and thermal conductivity, and high reset characteristics is formed on the surface of the metal foil.

Beneficial effects Compared with the prior art, the disclosure has the following advantages:

(1) The modified conductive agents are used by the functional coating and the conductive slurry of the disclosure as the conductive materials, have the unique dumbbell-shaped structure, form the bridge-island structure that is anchored at the both ends and can automatically adapt to and offset the change and the deformation of the size, etc. in the coating, have the magnetic anisotropy, and are arranged in a specific orientation arrangement under induction of the magnetic field. When applied into the lithium battery, the modified conductive agents can automatically adjust the oblique angle according to the internal volume change of the battery, and better establish the spatial network structure and reliably connect to the active ingredients. During expansion and contraction of the battery coating and the active materials caused by charging and discharging, the modified conductive agent can keep orderly spatial distribution, thus keeping the connection network and the electrical connection strength stable, and solving the problems that in the application to the lithium battery in the prior art, a coating is likely to fall off due to rapid deterioration of fixation force after numerous charging and discharging cycles.

(2) In the preparation process of the conductive slurry according to the disclosure, the modified conductive agent, the modified nano-cellulose and the dispersant are mixed and used. The dispersant modifies a surface of the modified conductive agent in a non-covalent way, weakens van der Waals force between molecules, reduces surface energy of the molecules, and well disperses the modified conductive agent in an aqueous solution. The modified nano-cellulose provides a three-dimensional porous network structure for the modified conductive agent and other components in the functional coating, and generates electrostatic repulsion among fibers through negatively charged groups to form a stable colloid, so as to stably bind the modified conductive agent to developed holes of the modified nano-cellulose, and play an auxiliary dispersion role. Under the combined action of the dispersant and the modified nano-cellulose, the magnetically-modified conductive agent is well dispersed in the conductive slurry, and free of aggregation and agglomeration, and the modified conductive agent is advantageously caused to be in the orientation arrangement under the induction of the magnetic field in the subsequent process.

(3) According to the disclosure, the external magnetic field is continuously applied during preparation and coating processes of the conductive slurry, such that the magnetically-modified conductive agent in the functional coating is induced to form the induced magnetic moment under the action of the strong magnetic field, and the magnetically-modified conductive agents are ordered, and are arranged obliquely at the specific angle of 15° to 45° and in parallel in the thickness direction in the coating.

(4) The modified conductive agent in the functional coating of the disclosure is composed of the carbon nanotubes. The carbon nanotubes can be used as ion diffusion channels based on a greater inner diameter size of the carbon nanotubes, and exert a channel effect. Thus, Li+ ions quickly penetrates the coating along inner cavities of the carbon nanotubes, a diffusion rate of the Li+ ions is improved, a migration path of the Li+ ions is shortened, and impedance is reduced by improving electron transfer efficiency. The modified conductive agent plays a role in improvement of the rate performance and a low-temperature performance of the battery when applied to the lithium battery.

(5) The oriented parallel array of the magnetically-modified conductive agents in the functional coating of the disclosure provides the functional coating with the magnetic orientation. A combination of magnetic current collectors that have positive electrodes and negative electrodes is used as the battery, such that a stable magnetic field is formed between the current collectors that have the positive electrodes and the negative electrodes in the battery, that is, a constraint from the magnetic field makes the migration of the lithium ions regular. On the other hand, the lithium ions regularly moves to penetrate a diaphragm of the lithium battery, improving penetration efficiency of the diaphragm, and reducing the impedance of the diaphragm. For the lithium battery assembled with the magnetic current collectors that have opposite polarities according to the disclosure, a capacity can be obviously improved, the impedance reduced, and the battery cycle performance is improved. In addition, the lithium battery can adapt to and offset the volume change and maintain the reliable connection, safety of the lithium battery in high-power discharging can be further improved, an energy utilization rate and charging efficiency of the charging and discharging can be improved, and charging time is shortened.

(6) The functional coating of the disclosure constructs the three-dimensional network structure in which the modified conductive agent and a flexible binder substrate material are interwoven with each other, and provides a connection layer that has a high strength and conductive efficiency and desirable flexibility. Thus, a contact area between the rigid metal current collector and the conductive slurry can be effectively expanded, the fixation force of the coating can be improved, the interface resistance between the current collector and the active materials of the battery can be effectively reduced, the electrochemical stability of the current collector material can be increased, a rise of the internal resistance of the battery can be avoided, and negative impact on the battery performance, especially under the condition of high current charging and discharging can be reduced. In addition, by using the three-dimensional interwoven network anchored at both ends of the modified conductive agent, the volume change in the charging and discharging processes is reduced, the reliability of the electrical connection is improved, expansion and separation of the conductive slurry from the current collector are avoided, the permanent fixation force between the current collector metal foil substrate and the active material of the battery during repeated charging and discharging is enhanced, the stability of the electrode foil is improved, a cycle failure is avoided, and a specific capacity, cycle stability and a rate performance of the electrode can be improved. Thus, the functional coating according to the disclosure and the lithium battery prepared with the functional coating have a high capacity, a long cycle life, a desirable rate performance, etc.

(7) According to the disclosure, through introduction of the modified carbon nanotubes and effective construction of the three-dimensional network, more contact sites are provided for active particles, a specific surface area in contact with the active materials is expanded, and the fixation force of the positive or negative material on the current collector is greatly enhanced. Thus, the current collector of the disclosure can appropriately reduce a proportion of the binder in the battery positive electrode/negative electrode slurry, further reduce the internal resistance, and advantageously improve an energy density of the battery. The resistance of the positive electrode foil prepared by adopting the current collector of the disclosure is merely ⅓ of a resistance of a pure polished foil while stripping force of the positive electrode foil is 4 times larger than stripping force of the pure polished foil, and an alternating-current internal resistance of the prepared lithium-ion battery is reduced by 42% or higher compared with an alternating-current internal resistance of a lithium-ion battery prepared with the polished foil current collector.

(8) The current collector according to the disclosure can obviously improve the energy density of the battery and improve the cycle life and rate performance. Under a system of 1 C rate charging and 2 C rate discharging, after 2000 cycles at a room temperature, a capacity retention rate of the lithium-ion battery prepared by adopting the current collector of the disclosure can reach 93%, and is much higher than a capacity retention rate of the polished foil current collector of 80%, and cycle consistency of the battery is obviously better than cycle consistency of the pure polished foil current collector.

(9) The preparation methods for the high-performance lithium battery current collector and the conductive slurry according to the disclosure has readily available materials, simple steps, high controllability and low preparation costs. The functional coating of the current collector prepared has a unique upper and lower double-layer internal aggregation structure and excellent mechanical properties, and has great development potential and application value in the field of traction lithium battery manufacturing.

### DETAILED DESCRIPTION

The disclosure will be further expounded in detail below in conjunction with a plurality of examples.

### EXAMPLES

A high-performance lithium-ion battery current collector and a conductive slurry, and preparation methods therefor according to the disclosure may be applied to manufacture of lithium batteries with technical routes such as lithium cobaltate (LCO), lithium manganate (LMO), lithium iron phosphate (LFP), and ternary materials (lithium nickel cobalt manganate (NCM) and lithium nickel cobalt manganese oxide (NCA)), may adapt to various diaphragms and electrolytes, and is wide in application range.

A high-performance lithium battery current collector includes a metal foil and a functional coating. The functional coating is a functional layered covering structure with a thickness of no more than 800 nm formed by coating a conductive slurry on one or both surfaces of the metal foil and drying. The functional coating includes a plurality of strip-shaped modified conductive agents, and the modified conductive agent is magnetically-oriented modified multi-walled carbon nanotube. After being cured and molded, the modified conductive agents are parallel to one another in the functional coating, axes of the modified conductive agents are arranged obliquely relative to a surface of the metal foil at an included angle of 15° to 45° within a thickness of the functional coating, and the modified conductive agents are interwoven with a modified nanofiber, a binder and the conductive agent in the coating, so as to form an oriented three-dimensional network connection structure with enhanced fixation, electrical conductivity and thermal conductivity, and uniform deformation and resetting.

The modified conductive agent, that is, the magnetically-oriented modified multi-walled carbon nanotubes in the functional coating are modified multi-walled carbon nanotubes with a dumbbell-shaped structure whose inner diameter is not less than 5 nm, outer diameter is not greater than 20 nm, and length is not greater than 1200 nm. After being oxidized and chemically modified, the modified multi-walled carbon nanotubes have a dumbbell-shaped fiber structure with two thicker ends and a thinner middle, and thicker lower ends are respectively connected to the surface of the metal foil and upper ends are connected to one another after an orientation arrangement of the modified multi-walled carbon nanotubes. Other conductive agent particles with different sizes and the modified nanofiber are sandwiched in a thinner fiber part in the middle under the action of cooperation of a binder, such that all parts are connected to one another to form a three-dimensional network with a bridge-island structure that has both ends anchored and is of the orientation arrangement. An elastic three-dimensional network limits deformation and displacement of the modified multi-walled carbon nanotubes and the conductive agent particles during a work process of a battery, so as to automatically adapt to and offset an internal volume change, and the deformation and the displacement of the conductive particles during charging and discharging processes of the lithium battery, and maintain reliability of the functional coating for a connection between the surface of the metal foil and an active material.

A conductive slurry for preparing the high-performance lithium battery current collector is provided. The conductive slurry is an aqueous slurry prepared by dispersing and mixing a modified conductive agent (a modified multi-walled carbon nanotube), a nano-conductive agent, a modified nanofiber, a dispersant, a binder and a solvent, and the slurry has a solid content of 0.1% to 5%, a viscosity of 200 mPa·s to 1000 mPa·s (25° C.), and a pH of 8 to 11.

A weight ratio of raw material components of the conductive slurry is as follows: the modified conductive agent (that is, the modified multi-walled carbon nanotube):the nano-conductive agent:the modified nanofiber:the dispersant:the binder:the solvent=(0.01-1.8):(0.01-0.2):(0.02-2):(0.02-20):(0.05-20):(56-99.89).

A method for preparing the conductive slurry for preparing the high-performance lithium battery current collector includes:

S1, materials are prepared: a modified conductive agent (a modified multi-walled carbon nanotube), a nano-conductive agent, a modified nanofiber, a dispersant, a binder and a solvent are prepared in proportion.

S2, a high-concentration modified conductive agent suspension is prepared: the modified nanofiber and the dispersant are weighed in proportion and added into ⅓ of the solvent, and the modified nanofiber and the dispersant are completely dissolved through mechanical stirring. A modified conductive agent of an amount required is weighed and added into a mixed solution, and ultrasonic treatment is performed for 30 min. A modified conductive agent suspension, specifically a high-concentration modified multi-walled carbon nanotube suspension is obtained.

S3, magnetizing is performed: a modified multi-walled carbon nanotube and nano-conductive agent dispersion solution is placed in a strong external magnetic field for magnetization to further stimulate the magnetic anisotropy of magnetically-modified multi-walled carbon nanotube to obtain the high-concentration magnetically-modified multi-walled carbon nanotube suspension.

S4, preliminary dispersion is performed: a binder is added in a corresponding proportion to the high-concentration magnetically-modified multi-walled carbon nanotube suspension, the solvent is supplemented to a required amount, and the preliminary dispersion is performed by sequentially using a high-speed vacuum disperser and a sand mill. The vacuum disperser has a shearing speed of 10 m/s to 25 m/s, a vacuum degree not lower than 0.085 MPa, and vacuum dispersing time of 1 h to 5 h during dispersion, and the sand mill includes sand mill beads that have a diameter of 0.2 mm to 2 mm and account for 30% to 90%, and has a sand mill speed of 600 r/min to 10000 r/min and sand mill time of is 0.1 h to 5 h.

S5: secondary dispersion is performed: the secondary dispersion is performed using an ultrasonic processing apparatus in an ultrasonic resonance manner, alternating magnetic fields are applied at two sides to further disperse the modified multi-walled carbon nanotubes and nano-conductive agent particles and align them in the same direction under induction of the magnetic field, so as to prepare the magnetically-oriented conductive slurry.

A method for preparing the high-performance lithium battery current collector includes:

(A1) a metal foil of the current collector and a dispersed conductive slurry are prepared, and a coating apparatus, an ultrasonic apparatus, a constant magnetic field generator, and a drying device are arranged.

(A2) the dispersed conductive slurry is coated on a surface of the metal foil, and a liquid colloid coating that has a viscosity of 200 mPa·s to 1000 mPa·s at 25° C. and a thickness of 500 nm to 1200 nm on the surface is formed.

(A3) a constant magnetic field that has a direction perpendicular to the surface of the metal foil is continuously applied to the liquid colloid coating, and under induction of the external magnetic field, oriented modified conductive agents in the coating are caused to be orderly arranged, gradually straightened from an original winding state, in a parallel arrangement array, and interwoven with a substrate.

(A4) the coating is dried, a solvent and a volatile component are evaporated, a constant magnetic field is continuously applied, the modified conductive agents are caused to keep an arrangement position and posture, and to be quickly set along with a rapid increase in a viscosity of the coating, and to be arranged obliquely at an angle of 15° to 45° and in parallel in a thickness direction until a solidifiable component of the coating conductive slurry is fixed to the surface of the metal foil, and forms a dense functional covering structure that has a thickness not less than 800 nm, that is, a three-dimensional network connection structure with enhanced fixation, electrical conductivity and thermal conductivity, and high reset characteristics is formed on the surface of the metal foil.

### Example 1

This example is a concrete application case. A metal foil substrate used in this example is an aluminum foil with a thickness of 10 μm to 15 μm.

A high-performance lithium battery current collector according to the disclosure includes a metal aluminum foil and a functional coating. The functional coating is a functional covering structure with a thickness of 700 nm formed by coating a conductive slurry on both surfaces of the metal foil and drying. The functional coating has magnetic orientation.

In this example, axes of modified conductive agents, that is, modified multi-walled carbon nanotubes in the functional coating are obliquely arranged at a specific included angle of 45° with the surface of the metal aluminum foil in a thickness direction, and are interwoven with substrate materials such as a binder, so as to form a three-dimensional network structure with enhanced fixation, electrical conductivity and thermal conductivity.

The magnetically-modified conductive agent adopted in the disclosure forms an array distributed in parallel, such that carriers can move in a direction of the modified conductive agent array, and a propagation speed of the carrier is faster. In addition, recombination of the carrier during transmission can be avoided, such that the magnetically-modified conductive agent has desirable orientated conductivity and can quickly guide the carrier to the metal foil.

In this example, the modified conductive agent is prepared specifically as follows:

(1) Carbon nanotubes are oxidized: 2 g of multi-walled carbon nanotubes and a mixture of 200 mL of concentrated sulfuric acid and concentrated nitric acid [V_{(concentrated HNO3)}:V_{(concentrated H2SO4)}=1:3] are placed in a conical flask of 500 mL for ultrasonic treatment for 2 h, and the carbon nanotubes are dispersed in an acid solution. The mixture is placed in a constant-temperature magnetic stirrer, and stirred at 55° C. for 6 h, and the carbon nanotubes are oxidized and cut into short tubes of 150 nm to 400 nm (a specific length in this example is 150 nm to 300 nm). Then diluting is performed with deionized water, vacuum filtration is performed with a filter membrane of 0.22 μm, and washing with deionized water and filtering are repeated until a pH of filtrate is close to 7. A black solid on the filter membrane is collected, it is dried in a vacuum drying oven at 60° C. for 24 h, and it is ground through a 200-mesh screen, and a single layer of carbon nanotubes are shortened, oxidized and purified. During oxidation, a vacancy defect is formed between internal grids of short carbon nanotubes, the short carbon nanotubes have local magnetic moment, and the multi-walled carbon short nanotubes have weak magnetism.

(2) The carbon nanotubes are ammoniated: 1 g of oxidized carbon nanotubes and 6 g of 1,6-hexamethylenediamine are weighed and placed in 30 mL of acetone, ultrasonic treatment is performed for 1 h, 0.4 g of condensing agent dicyclohexylcarbodiimide (DCC) is added, uniform mixing is performed, and refluxing and heating are performed at 70° C. for 32 h. Excess 1,3-hexamethylenediamine, dicyclohexylcarbodiimide (DCC) and reaction by-products are ultrasonically washed off with ethanol absolute, and vacuum filtration is performed with 0.22 μm of filter membrane and a membrane filter. Repeated washing is performed with ethanol absolute, a black substance on the filter membrane is collected, then it is dried in a vacuum drying oven at 65° C. for 24 h, and it is ground through a 200-mesh screen to obtain amino-modified magnetic carbon nanotubes.

(3) The dumbbell-shaped structures are constructed: 0.5 g of amino-modified magnetic multi-walled carbon nanotubes and 0.7 g of nano-conductive carbon black are weighed and placed into 30 mL of acetone, ultrasonic dispensing is performed for 1 h, a condensing agent DCC is added, and performing refluxing and heating are performed at 70° C. for 24 h. Excess DCC and reaction by-products are ultrasonically washed off with ethanol absolute, and vacuum filtration is performed with 0.45 μm of filter membrane and a membrane filter. repeated washing is performed with ethanol absolute, a black substance on the filter membrane are collected, it is dried in a vacuum drying oven at 65° C. for 24 h, and it is ground through a 200-mesh screen to separate and obtain the modified conductive agents with two thicker ends and a thinner middle and the dumbbell-shaped structure.

The multi-walled carbon nanotubes used in the example of the disclosure has an inner diameter not less than 5 nm, an outer diameter not more than 20 nm, and a length not more than 1200 nm before cutting.

In the example of the disclosure, the step of oxidization is as follows: unstable five-membered carbon rings and seven-membered carbon rings at a place where the carbon nanotubes are spirally twisted due to a large length-diameter ratio thereof are broken by using oxidation of mixed acid, the short carbon nanotubes with two open ends are formed by performing cutting, and the treated carbon nanotubes are shortened with top ends opened. C atoms at an end opening are oxidized into carboxyl groups through continuous oxidation, and a grafting reaction is performed by providing a plurality of contact sites at the end opening. The carbon nanotubes have weak magnetism since the shortened carbon nanotubes have a vacancy defect formed due to local C—C bonds being opened by oxidation, and magnetic moment is caused near the defect due to the defect. In addition, impurities are oxidized by concentrated acid based on high reactivity caused by a structural defect or a local high curvature of the carbon nanoparticles, amorphous carbon and graphite fragments, and selectively removed accordingly.

The diamine compound in the example of the disclosure may use one of diamine compounds such as 1,6-hexamethylenediamine, 1,4-butanediamine and p-phenylenediamine. An amino group contained therein reacts with a carboxyl group of an end opening of the single-layer carbon nanotube port to form an amido bond, and the other amino group is exposed, thus completing amino modification of the carbon nanotube. Grafted diamine opens adjacent and tight carbon nanotubes, and expands a gap between the carbon nanotubes. In addition, steric hindrance of diamine weakens a hydrogen bond formed between the multi-walled carbon nanotubes in an acidification process, and makes ammoniated carbon nanotubes better dispersed, which is beneficial to subsequent grafting of nano-conductive particles containing a large number of carboxyl groups. In Example 1, 1,6-hexamethylenediamine is specifically used.

One of dicyclohexylcarbodiimide (DCC), N,N′-Diisopropylcarbodiimide (DIC) or 1-Ethyl-3-(3-dimethylaminopropyl)carbodiimide (EDCI) can be used as the condensing agent in the example of the disclosure, and a functional feature of the condensation agent is that the condensation agent promotes a reaction between the amino group and the carboxyl groups to form the amido bond and be connected together as a dehydrating agent. In this example, dicyclohexylcarbodiimide (DCC) is specifically used.

The inert solvent in the example of the disclosure can be one of acetone, xylene, etc. In this example, acetone is specifically used.

The nano-conductive agent particles of the disclosure may adopt one of carbon black and graphite oxide, and have a particle size of 20 nm to 250 nm, and a large number of carboxyl groups on surfaces of the nano-conductive agent particles and the amino-modified carbon nanotubes react to form amido bonds and to be connected together. In Example 1, the nano-conductive carbon black is used, with an average particle size of 120 nm.

A conductive slurry for preparing the high-performance lithium battery current collector is provided. The conductive slurry is an aqueous slurry prepared by dispersing and mixing a modified conductive agent, a modified nanofiber, a dispersant, a binder and a solvent, and the slurry has a solid content of 0.1% to 10%, a viscosity of 200 mPa·s to 1000 mPa·s at 25° C., and a pH of 8 to 10, which can be specifically selected by those skilled in the art. In this example, the slurry has a solid content of 8.5%, a viscosity of 500 mPa·s at 25° C., and a pH of 9.

The functional coating after being coated and before being dried has a thickness of about 800 nm to 1200 nm, and provides sufficient space for the modified conductive agent to untwist, straighten and orientate. By controlling the viscosity in a specific area, the condition that the modified conductive agents slip or float to the surface and get evaporated along with a volatile component in the slurry is avoided while the modified conductive agents are untwisted, straightened and orientated advantageously under the induction of the magnetic field. The modified conductive agents are captured in grid structures of the substrate and interwoven with the substrate to form the three-dimensional network structure.

In Example 1, a weight ratio of raw material components of the conductive slurry is as follows: the modified multi-walled carbon nanotube:the nano-conductive agent:the modified nanofiber:the dispersant:the binder:the solvent=0.3:0.05:5:20:20:54.65.

In the example of the disclosure, the modified nanofiber may adopt one of a cellulose nanofiber and a chitin (ChNF) nanofiber that are modified by carboxylation, sulfonation, phosphorylation and quaternization, and has a solid content of 0.1 wt % to 3.0 wt % when dispersed in a deionized water medium. The modified nanofiber is applicable to an aqueous medium, provides a three-dimensional porous network structure as a functional feature, and generates electrostatic repulsion among fibers through negatively charged groups to form a stable colloid, so as to stably bind a magnetically-modified conductive agent to developed holes of the modified nanofiber and play an auxiliary dispersion role. In addition, the modified nanofiber are interwoven with the carbon nanotubes in a functional coating to form the three-dimensional network structure, thus improving a comprehensive performance of the current collector; in this Example 1, carboxylated cellulose nanofibers are specifically used.

The dispersant of the example of the disclosure may adopt a mixture of one of polyvinyl pyrrolidone (PVP), polyvinyl acetate (PVA) or poly(N-vinyl acetamide) (PNVA), and resin used by the binder. A use amount of the dispersant (including a single-component or multi-component mixture) is generally 20 to 1000 times of a weight of dry powder of the carbon nanotubes. The dispersant is applicable to an aqueous medium, and has a functional feature of uniformly dispersing the modified conductive agent in a conductive slurry system. In Example 1, polyvinyl pyrrolidone (PVP) is specifically used.

The binder in the example of the disclosure may adopt a resin that is resistant to an electrolyte of a lithium ion battery and a high voltage. The resin is polyacrylic acid (PAA) that has a wide molecular weight distribution and a salt thereof, isopropanol, or a modified acrylic resin, or modified polyacrylonitrile (PAN) resin. The binder has a solid content of 5 wt % to 30 wt % when dispersed in deionized water, and the binder is applicable to an aqueous medium, and has functional features of binding the conductive slurry between a current collector body and a positive material/a negative material, and further improving a fixing capacity therebetween. In Example 1, isopropanol is specifically used.

The solvent used in Example 1 of the disclosure is deionized water.

A method for preparing the conductive slurry for preparing the high-performance lithium battery current collector includes:

(1) Materials are prepared: a modified conductive agent, a modified nano-cellulose, a dispersant, a binder and a solvent. The modified multi-walled carbon nanotube:the nano-conductive agent:the modified nanofiber:the dispersant:the binder:the solvent=0.3:0.05:5:20:20:56.45.

(2) A high-concentration modified conductive agent suspension is prepared: the modified nanofiber and the dispersant are weighed in proportion and added into ⅓ of the solvent, and the modified nanofiber and the dispersant are completely dissolved through mechanical stirring. A modified conductive agent of an amount required is weighed and added into a mixed solution, and ultrasonic treatment is performed for 30 min. A modified conductive agent suspension, specifically a high-concentration modified multi-walled carbon nanotube suspension is obtained.

(3) Magnetizing is performed: the modified conductive agent suspension is placed in a strong external magnetic field for magnetization to cause a vacancy defect in the carbon nanotubes in the modified conductive agent to form induced magnetic moment, further excite magnetic anisotropy of magnetically-modified conductive agent, and obtain the high-concentration magnetically-modified multi-walled carbon nanotube suspension.

(4), Preliminary dispersion is performed: a binder in a corresponding proportion is added to the high-concentration modified conductive agent suspension, and the solvent is supplemented to a required amount. The preliminary dispersion is performed by sequentially using a high-speed vacuum disperser and a sand mill. The vacuum disperser has a shearing speed of 10 m/s to 25 m/s, a vacuum degree not lower than 0.085 MPa, and vacuum dispersing time of 1 h to 5 h during dispersion, and the sand mill includes sand mill beads that have a diameter of 0.2 mm to 2 mm and account for 30% to 90%, and has a sand mill speed of 600 r/min to 10000 r/min and sand mill time of is 0.1 h to 5 h.

(5) Secondary dispersion is performed: the secondary dispersion is performed using an ultrasonic processing apparatus in an ultrasonic resonance manner, alternating magnetic fields are applied at two sides to further uniformly disperse and orient the magnetically-modified conductive agents are in the same direction under induction of the magnetic field, so as to obtain the magnetically-oriented conductive slurry. The ultrasonic processing apparatus is an ultrasonic generator placed in the solution, an ultrasonic frequency of each power unit is 20 kHz to 40 kHz, and power is 1 kW to 3 kW. An intensity of the magnetic field is 0.1 T to 5 T and a frequency is 40 Hz to 60 Hz.

In the steps (4) and (5), during the dispersion process, the pH value of the conductive slurry is adjusted to 8 to 11 with ammonia water to maintain stability of the slurry.

In Example 1 of the disclosure, the specific component ratio and a part of preparation operation steps of the conductive slurry are as follows: 20 g of 10% polyvinyl pyrrolidone (PVP K30) solution and 5 g of 1% carboxylated nano-cellulose solution are added into 13 g of deionized water, and fully mixed. Then, 0.3 g of modified multi-walled carbon nanotubes and 0.05 g of nano-conductive agents are added into a mixed solution, and ultrasonic treatment is performed for 30 min, such that the suspension of magnetically-modified conductive agent may be obtained. The suspension of the magnetically-modified conductive agents is magnetized in a strong external magnetic field. 20 g of isopropanol and 43.45 g of deionized water are added into the magnetized suspension of the magnetically-modified conductive agent, pre-dispersing is performed by a high-speed disperser for 30 minutes (stirring at a low speed first before accelerating), then dispersing is performed in vacuum at 2400 RPM for 120 minutes (a vacuum degree to be greater than 0.08 MPa) after the slurry is basically stirred uniformly, and then sanding is performed. Sanding is performed at 3000 rpm for 10 min, the above treated slurry is subjected to ultrasonic dispersion again, alternating magnetic fields re applied on two sides, and the oriented aqueous conductive slurry with a solid content of 2.1% is obtained. The aqueous conductive slurry with a solid content of 0.1% to 6% can also be prepared by adjusting the use amounts of the magnetically-modified conductive agent, the modified nano-cellulose, the dispersant and the binder in the above formula.

A method for preparing the high-performance lithium battery current collector includes:

(1) A metal foil of the current collector and a dispersed conductive slurry are prepared, and a coating apparatus, an ultrasonic apparatus, a constant magnetic field generator, and a drying device are arranged.

(2) The dispersed conductive slurry is coated on a surface of the metal foil of the current collector, and a liquid colloid coating that has a viscosity of 200 mPa·s to 1000 mPa·s at 25° C. and a thickness of 800 nm to 1000 nm is formed on the surface. The coating after being coated and before being dried has a thickness of about 800 nm to 1200 nm, and provides sufficient space for the magnetically-modified conductive agent to untwist, straighten and orientate under induction of a magnetic field. By controlling the viscosity in a specific area, the condition that the modified conductive agents slip or float to the surface and get evaporated along with a volatile component in the slurry is avoided while conditions are provided for an orientation effect under the induction of the magnetic field. The modified conductive agents are captured in grid structures of a substrate and interwoven with the substrate to form a three-dimensional network structure.

(3) A stable magnetic field that has a direction perpendicular to the surface of the metal foil is applied to the liquid colloid coating, magnetically-oriented modified conductive agents in the coating are caused to generate induction magnetic moment under induction of the magnetic field, and an orientation arrangement array is formed under the induction of the magnetic field.

A specific step that the orientation is induced by applying an external magnetic field includes: in a first one-third process of a coating production line, an orientation magnetic field that has an included angle of 45 degrees with the surface of the metal foil is applied, and the magnetic field has a strength of 200 mT to 1000 mT, such that first orientation positioning of the magnetically-modified conductive agents is completed, and magnetic single-layer carbon nanotubes that are disordered during the coating are re-oriented. Then, in a last two-thirds process of the coating production line, an orientation magnetic field with an included angle of 45 to 90 degrees is applied to the surface of the metal foil, and a uniform magnetic field with a magnetic field strength of 500 mT to 1000 mT completes second orientation positioning, such that the magnetically-modified conductive agents finally form a specific oblique array with an angle of 15° to 45° in a thickness direction in the coating and sets same along with continuous increasing of a viscosity of the coating.

(4) The coating is dried, a solvent and a volatile component are fully evaporated, and a constant magnetic field is continuously applied. An arrangement position and posture are kept, and quick setting is implemented along with a rapid increase in a viscosity of the coating until a solid content of a component of the coating conductive slurry is fixed to the surface of the metal foil, and a dense functional covering structure that has a thickness not less than 800 nm is formed, and includes a three-dimensional network connection structure with enhanced fixation, electrical conductivity and thermal conductivity on the surface of the metal foil.

Step (3) further includes:

(31) In the first one-third process of the coating production line, the temperature of the conductive slurry or the coated coating is raised to 45° C. to 65° C. for pre-drying to prolong coagulation time and thereby reducing the viscosity of a liquid colloidal coating, and increasing kinetic energy of the single-layer carbon nanotubes to untwist, straighten and orientate.

The high-performance lithium battery current collector made in Example 1 is applied to manufacture of the lithium-ion battery and a performance test thereof. An electrode is made with the following parameters, and a positive electrode foil includes a current collector and a positive active material layer coated on the current collector. The current collector is a high-performance lithium battery current collector manufactured in this example. The positive active material layer consists of that follow raw materials of, by weight: 93 parts of positive materials (LFP), 4 parts of positive conductive agents (SP) and 3 parts of positive binders (PVDF-5130).

A negative electrode foil includes a current collector and a negative active material layer coated on the current collector. The current collector is a polished copper foil. The negative electrode active material layer consists of the following raw materials of, by weight: 96 parts of negative materials (artificial graphite), 1 part of negative conductive agent (SP), 1 part of negative binder 1 (sodium carboxymethylcellulose (CMC)) and 2 parts of negative binders 2 (styrene butadiene rubber (SBR)).

A 18650 battery is assembled by using the positive electrode foil and the negative electrode foil, a 20 μm of polypropylene (PP) diaphragm and LiPF6 electrolyte. See Table 1 and Table 2 for a measured performance of the electrode foil and a performance of the battery.

### Comparative example 1

In Comparative Example 1, a positive current collector is prepared by using a polished aluminum foil, with the other preparation conditions identical.

By using the high-performance lithium battery current collector prepared in Example 1 and directly using the polished aluminum foil as the positive current collector, the 18650 battery is prepared with the same formula and process of positive and negative electrodes of the lithium battery, and the electrode foil performance and battery performance are tested. The tested electrode foil performance and battery performance are shown in Table 1 and Table 2.

TABLE 1
Comparative test data of a high-performance lithium battery current
collector applied to a positive electrode foil of the disclosure

| | | | Stripping | Stripping force (N) |
|---|---|---|---|---|
| | | | force (N) | of a positive |
| | | Resistance of | of a | electrode foil after |
| Type of an | | a positive | positive | 2000 cycles of 1 C |
| electrode | Serial | electrode | electrode | rate charging and |
| foil | No. | foil (Ω) | foil | 2 C rate discharging |
| Example 1 | 1 | 3.31 | 17.313 | 15.413 |
| | 2 | 3.35 | 17.521 | 15.230 |
| | 3 | 3.32 | 17.446 | 15.331 |
| | Average | 3.34 | 17.427 | 15.325 |
| Comparative | 1 | 11.81 | 4.516 | 3.210 |
| example 1 | 2 | 11.60 | 4.874 | 3.455 |
| | 3 | 11.47 | 4.450 | 3.107 |
| | Average | 11.63 | 4.613 | 3.257 |

TABLE 2
Comparative test data of a high-performance lithium battery current collector
applied to a lithium-ion battery of the example of the disclosure

| | | | | Capacity (mAh) | Capacity retention |
|---|---|---|---|---|---|
| | | | | after 2000 cycles | rate (%) after |
| | | Internal | Capacity (mAh) | of 1 C rate | 2000 cycles of |
| | | resistance of | after capacity | charging and | 1 C rate charging |
| Type of | Serial | a battery | grading of | 2 C rate | and 2 C rate |
| a battery | No. | (mΩ) | a battery | discharging | discharging |
| Example 1 | 1 | 14.4 | 1620.2 | 1505.7 | 92.9 |
| | 2 | 14.6 | 1618.4 | 1500.0 | 92.7 |
| | 3 | 14.7 | 1617.9 | 1504.1 | 93.0 |
| | Average | 14.6 | 1618.8 | 1503.3 | 92.8 |
| Comparative | 1 | 25.1 | 1616.3 | 1263.9 | 78.2 |
| example 1 | 2 | 26.2 | 1615.5 | 1316.6 | 81.5 |
| | 3 | 24.8 | 1615.8 | 1295.8 | 80.2 |
| | Average | 25.4 | 1615.8 | 1292.1 | 80.0 |

According to the test results, a conclusion is readily drawn that when applied to manufacture of the lithium battery, the high-performance lithium battery current collector according to the disclosure has performances of the electrode foil and the battery superior to those in a solution of using the polished foil as the current collector in Comparative Example 1. The resistance of the positive electrode foil prepared in Example 1 is merely ⅓ of a resistance of Comparative Example 1 of a pure polished foil current collector while stripping force of the positive electrode foil is 4 times larger than stripping force of the pure polished foil current collector. An alternating-current internal resistance of the battery in Example 1 is measured to be 42% lower than an alternating-current internal resistance of the polished foil. At a room temperature, the capacity retention rate of the lithium-ion battery prepared in Example 1 can reach 93% after 2000 cycles of 1 C rate charging and 2 C rate discharging, and is much higher than a capacity retention rate of 80% of the polished foil current collector solution in Comparative Example 1, and cycle consistency of the lithium-ion battery is also obviously better than cycle consistency of the pure polished foil current collector solution.

### Example 2

A high-performance lithium battery current collector and a conductive slurry, and preparation methods therefor according to by this example are basically the same as those of Example 1 with differences as follows:

A modified conductive agent for preparing the high-performance battery current collector is provided. The modified conductive agent is prepared as follows: multi-walled carbon nanotubes are oxidized and chemically modified, and then are connected to other large-scale nano-conductive agent particles, so as to form a dumbbell-shaped bridge-island structure anchored at both ends. And in Example 2, 1,4-butanediamine is used as a modifier and N,N′-Diisopropylcarbodiimide (DIC) is used as a condensing agent.

A conductive slurry for preparing the high-performance lithium battery current collector is provided. The conductive slurry is an aqueous slurry prepared by dispersing and mixing a modified conductive agent, a modified nanofiber, a dispersant, a binder and a solvent, and the slurry has a solid content of 4% to 6%, a viscosity of 300 mPa·s to 1000 mPa·s at 25° C., and a pH of 8 to 9.

In Example 2, a weight ratio of raw material components of the conductive slurry is as follows: the modified multi-walled carbon nanotube:the nano-conductive agent:the modified nanofiber:the dispersant:the binder:the solvent=0.6:0.1:6:20:20:53.3.

The modified nano-cellulose in Example 2 is carboxylated chitin nanofiber, the binder is modified acrylic resin, and the dispersant is polyvinyl acetate (PVA).

In Example 2, the high-performance lithium battery current collector is prepared through coating on the copper foil.

Compared with the tested current collector, preparation parameters of a negative electrode foil of a lithium-ion battery with the current collector in Example 2 are as follows: a negative electrode foil includes a current collector and a negative active material layer coated on the current collector. The current collector is the high-performance lithium battery current collector prepared in Example 2. The negative electrode active material layer consists of the following raw materials of, by weight: 96 parts of negative materials (artificial graphite), 1 part of negative conductive agent (SP), 1 part of negative binder 1 (sodium carboxymethy Icellulose (CMC)) and 2 parts of negative binders 2 (styrene butadiene rubber (SBR)). A stripping strength of the electrode foil is tested with an electronic tension machine, and the resistance of the electrode foil is tested by an upper and lower double-probe pressing method. See Table 3 for the measured performance of the electrode foil.

### Example 3

A high-performance lithium battery current collector and a conductive slurry, and preparation methods therefor according to by this example are basically the same as those of examples 1 and 2 with differences as follows:

In a modified conductive agent for preparing the high-performance battery current collector, in Example 3, 1,6-hexamethylenediamine is used as a modifier and 1-Ethyl-3-(3-dimethylaminopropyl)carbodiimide (EDCI) is used as a condensing agent.

A conductive slurry for preparing the high-performance lithium battery current collector is provided. The conductive slurry is an aqueous slurry prepared by dispersing and mixing a modified conductive agent, a modified nanofiber, a dispersant, a binder and a solvent, and the slurry has a solid content of 3% to 4%, a viscosity of 200 mPa·s to 800 mPa·s at 25° C., and a pH of 9 to 10.

In Example 3, a weight ratio of raw material components of the conductive slurry is as follows: the modified multi-walled carbon nanotube:the nano-conductive agent:the modified nanofiber:the dispersant:the binder:the solvent=0.3:0.1:4:12:14:69.6.

The modified nano-cellulose in Example 3 is carboxylated chitin nanofiber, the binder is modified polyacrylonitrile (PAN), and the dispersant is poly(N-vinyl acetamide) (PNVA).

In Example 3, the high-performance lithium battery current collector is prepared through coating on the copper foil.

Compared with the tested current collector, preparation parameters of a negative electrode foil of a lithium-ion battery with the current collector in Example 3 are as follows: a negative electrode foil includes a current collector and a negative active material layer coated on the current collector. The current collector is the high-performance lithium battery current collector prepared in Example 2. The negative electrode active material layer consists of the following raw materials of, by weight: 97 parts of negative materials (artificial graphite), 1 part of negative conductive agent (SP), 1 part of negative binder 1 (sodium carboxymethy Icellulose (CMC)) and 1 part of negative binder 2 (styrene butadiene rubber (SBR)). A stripping strength of the electrode foil is tested with an electronic tension machine, and the resistance of the electrode foil is tested by an upper and lower double-probe pressing method. See Table 3 (comparison test data of the high-performance lithium battery current collector of the disclosure applied to the negative electrode foil) for the measured performance of the electrode foil.

### Comparative Example 2

Preparation process parameters of a negative electrode foil of a lithium-ion battery are the same as those in Example 2. Specifically, negative material (artificial graphite):a conductive agent (SP):a binder 1(CMC):a binder 2(SBR)=96:1:1:2, but a difference is that a polished copper foil is used as a current collector. See Table 3 for a measured performance of the electrode foil.

### Comparative Example 3

Preparation process parameters of a negative electrode foil of a lithium-ion battery are the same as those in Example 3. Specifically, negative material (artificial graphite): a conductive agent (SP):a binder 1(CMC):a binder 2(SBR)=97:1:1:1, but a difference is that a polished copper foil is used as a current collector. See Table 3 for a measured performance of the electrode foil.

TABLE 3

| | Resistance (Ω) | Stripping force |
|---|---|---|
| | of a positive | (N) of a negative |
| Type of an electrode foil | electrode foil | electrode foil |
| Example 2 | 0.13 | 7.533 |
| Example 3 | 0.12 | 5.158 |
| Comparative example 2 | 0.14 | 4.385 |
| Comparative example 3 | 0.13 | 3.314 |

According to the test results, a conclusion is readily drawn that the negative electrode foil prepared by using the high-performance lithium battery current collector of the disclosure shows higher adhesion force of the electrode foil under the same amount of negative binders, and a resistance of the electrode foil is also lower than a resistance of a pure polished foil. It can be seen that the high-performance lithium battery current collector of the disclosure can appropriately reduce the proportion of the binder of the positive or negative slurry of the battery, further reduce the internal resistance, and advantageously improve the energy density of the battery.

To sum up, the high-performance lithium battery current collector of the disclosure adopts the magnetically-modified conductive agents to form the array distributed in parallel in the functional coating, successfully constructs the three-dimensional network structure in which the modified conductive agent and a flexible substrate is interwoven with each other, and provides a connection layer that has a high strength and conductive efficiency and desirable flexibility. Thus, a contact area between the rigid metal current collector and the conductive slurry can be effectively expanded, the fixation force of the coating can be improved, and the interface resistance between the current collector and the active materials of the battery can be effectively reduced. In addition, by using the interwoven network, the volume change in the charging and discharging processes is reduced, automatic reset is implemented, expansion and separation of the conductive slurry from the current collector are avoided, the permanent fixation force between the current collector metal foil substrate and the active material of the battery during repeated charging and discharging is enhanced, the stability of the electrode foil is improved, and a cycle failure is avoided. Thus, a specific capacity, cycle stability and a rate performance of the electrode can be improved, and comprehensive performances of the lithium battery can be greatly improved.

In other examples of the disclosure, the metal foil such as the copper foil, the iron foil or the stainless steel foil can also be used as the metal substrate of the current collector. In addition, under the working conditions of formula ratios and process steps of the components recorded in the disclosure, those skilled in the art can select specific components, ratios, processes and working conditions required according to the conventional technology, all of which can achieve the technical effects recorded in the disclosure. The examples of the disclosure will not be enumerated one by one.

The above examples are merely preferred examples of the disclosure, and are not intended to limit the protection scope of the disclosure, and any modification, equivalent replacement, improvement, etc. made to the technical solution of the disclosure within the spirit and principles of the disclosure should fall within the protection scope of the disclosure.

1. A high-performance lithium battery current collector, comprising a metal foil and a functional coating, wherein the functional coating is a functional layered covering structure with a thickness of no more than 800 nm formed by coating a conductive slurry on one or both surfaces of the metal foil and drying; the functional coating comprises a plurality of strip-shaped modified conductive agents, and the modified conductive agent is a magnetically-oriented modified multi-walled carbon nanotube; and after being cured and molded, the modified conductive agents are parallel to one another in the functional coating, axes of the modified conductive agents are arranged obliquely relative to a surface of the metal foil at an included angle of 15° to 45° within a thickness of the functional coating, and the modified conductive agents are interwoven with a modified nanofiber, a binder and the modified conductive agent in the coating, so as to form an oriented three-dimensional network connection structure with enhanced fixation, electrical conductivity and thermal conductivity, and uniform deformation and resetting; and
the magnetically-oriented modified multi-walled carbon nanotubes in the functional coating are modified multi-walled carbon nanotubes with a dumbbell-shaped structure, whose inner diameter is not less than 5 nm, outer diameter is not greater than 20 nm, and length is not greater than 1200 nm; after being oxidized and chemically modified, the modified multi-walled carbon nanotubes have a dumbbell-shaped fiber structure with two thicker ends and a thinner middle, and thicker lower ends are respectively connected to the surface of the metal foil and upper ends are connected to one another after an orientation arrangement of the modified multi-walled carbon nanotubes; other nano-conductive agent particles with different sizes and the modified nanofiber are sandwiched in a thinner fiber part in the middle under the action of cooperation of a binder, such that all parts are connected to one another to form a three-dimensional network with a bridge-island structure that has both ends anchored and is of the orientation arrangement; and an elastic three-dimensional network limits deformation and displacement of the modified multi-walled carbon nanotubes and the nano-conductive agent particles during a work process of a battery, so as to automatically adapt to and offset an internal volume change and the deformation and the displacement of the conductive particles during charging and discharging processes of the lithium battery, and maintain reliability of the functional coating for a connection between the surface of the metal foil and an active material.

2. The high-performance lithium battery current collector according to claim 1, wherein the modified multi-walled carbon nanotubes are prepared by the following steps:
(1) oxidizing the carbon nanotubes: taking an appropriate amount of multi-walled carbon nanotubes, placing them in a mixed solution of concentrated sulfuric acid and concentrated nitric acid in a volume ratio of 1:3 for ultrasonic treatment for 2 h, uniformly dispersing the multi-walled carbon nanotubes in the acid solution, and obtaining a dispersion solution; placing the dispersion solution in a constant-temperature magnetic stirrer, performing stirring at 55° C. for 6 h to oxidize the carbon nanotubes, and cutting the carbon nanotubes into short tubes of 150 nm to 400 nm; then diluting with deionized water, performing vacuum filtration with 0.22 μm of filter membrane and a membrane filter, and repeatedly washing with deionized water and filtering until a pH of filtrate is close to 7; and collecting a black solid on the filter membrane, drying it in a vacuum drying oven at 60° C. for 24 h, and grinding it through a 100-mesh screen to obtain truncated and purified oxidized multi-walled carbon nanotubes;
(2) ammoniating the carbon nanotubes: adding the oxidized multi-walled carbon nanotubes and excessive diamine compounds into an inert solvent, performing ultrasonic treatment for 1 h, adding a condensing agent, performing uniform mixing, and performing refluxing and heating at 70° C. for 32 h; ultrasonically washing off excess amine, dicyclohexylcarbodiimide (DCC) and reaction by-products with ethanol absolute, and performing vacuum filtration with 0.22 μm of filter membrane and a membrane filter; and
repeatedly washing with ethanol absolute, collecting a black substance on the filter membrane, then drying it in a vacuum drying oven at 65° C. for 24 h, and grinding it through a 200-mesh screen to obtain amino-modified magnetic multi-walled carbon nanotubes; and
(3) constructing the dumbbell-shaped structures: adding the amino-modified magnetic multi-walled carbon nanotubes and the nano-conductive agent particles into an inert solvent, performing ultrasonic dispensing for 1 h, adding a condensing agent, and performing refluxing and heating at 70° C. for 24 h; ultrasonically washing off excess condensing agents and reaction by-products with ethanol absolute, and performing vacuum filtration with 0.45 μm of filter membrane and a membrane filter; and repeatedly washing with ethanol absolute, collecting a black substance on the filter membrane, drying it in a vacuum drying oven at 65° C. for 24 h, and grinding it through a 200-mesh screen to obtain modified multi-walled carbon nanotubes with the two thicker ends and a thinner middle and a dumbbell-shaped structure.

3. The high-performance lithium battery current collector according to claim 2, wherein in step (1) of oxidizing the carbon nanotubes, unstable five-membered carbon rings and seven-membered carbon rings at a place where the carbon nanotubes are spirally twisted due to a large length-diameter ratio thereof are broken by using oxidation of mixed acid, the short carbon nanotubes with two open ends are formed by performing cutting, and the treated carbon nanotubes are shortened with top ends opened; C atoms at an end opening are oxidized into form carboxyl groups through continuous oxidation, and a grafting reaction is performed by providing a plurality of contact sites at the end opening; and the carbon nanotubes have weak magnetism since the shortened carbon nanotubes have a vacancy defect formed due to local C—C bonds being opened by oxidation, and magnetic moment is caused near the defect due to the defect.

4. The high-performance lithium battery current collector according to claim 2, wherein in step (3) of constructing the dumbbell-shaped structures, the nano-conductive agent particles are one of carbon black and graphite oxide, and has a particle size of 20 nm to 250 nm, a large number of carboxyl groups on surfaces of the nano-conductive agent particles and the amino-modified carbon nanotubes react to form amido bonds and to be stably connected together, and thicker anchoring parts are formed at both ends of the modified multi-walled carbon nanotubes.

5. The high-performance lithium battery current collector according to claim 2, wherein the diamine compound in step (2) is one of 1,6-hexamethylenediamine, 1,4-butanediamine and p-phenylenediamine, and an amino group contained therein reacts with a carboxyl group of an end opening of the carbon nanotube port to form an amido bond, and the other amino group is exposed, thus completing amino modification of the carbon nanotube; grafted diamine opens adjacent and tight carbon nanotubes, and expands a gap between the carbon nanotubes; and in addition, steric hindrance of diamine weakens a hydrogen bond formed between the multi-walled carbon nanotubes in an acidification process, and makes ammoniated carbon nanotubes better dispersed, which is beneficial to subsequent grafting of nano-conductive agent particles containing a large number of carboxyl groups;
the condensing agent in step (2) is dicyclohexylcarbodiimide (DCC) that is used as a dehydrating agent to promote the amino group and the carboxyl group to react to form the amido bond and to be stably connected together; and
the inert solvent in step (3) is one of acetone and xylene.

6. A conductive slurry for preparing the high-performance lithium battery current collector according to claim 1, wherein the conductive slurry is an aqueous slurry prepared by dispersing and mixing a modified multi-walled carbon nanotube, a nano-conductive agent, a modified nanofiber, a dispersant, a binder and a solvent, and the slurry has a solid content of 0.1% to 5%, a viscosity of 200 mPa·s to 1000 mPa·s, and a pH of 8 to 11; and
a weight ratio of raw material components of the conductive slurry is as follows: the modified multi-walled carbon nanotube:the nano-conductive agent:the modified nanofiber:the dispersant:the binder:the solvent=(0.01-1.8):(0.01-0.2):(0.02-2):(0.02-20):(0.05-20):(56-99.89).

7. The conductive slurry for preparing the high-performance lithium battery current collector according to claim 6, wherein
the modified nanofiber is one of a cellulose nanofiber and a chitin ChNF nanofiber that are modified by carboxylation, sulfonation, phosphorylation and quaternization, and has a solid content of 0.1 wt % to 3.0 wt % when dispersed in a deionized water medium; the modified nanofiber is applicable to an aqueous medium, provides a three-dimensional porous network structure, and generates electrostatic repulsion among fibers through negatively charged groups to form a stable colloid, so as to stably bind a modified conductive agent to developed holes of the modified nanofiber; and in addition, the modified nanofiber is interwoven with a modified conductive agent in a functional coating to form a three-dimensional network structure, thus improving a comprehensive performance of the current collector;
the dispersant is one of polyvinyl pyrrolidone (PVP), polyvinyl acetate (PVA) or poly(N-vinyl acetamide) (PNVA), an amount of the dispersant is 20 to 1000 times of a weight of dry powder of the modified conductive agent, and the dispersant is applicable to an aqueous medium, and uniformly disperses the modified conductive agent in a conductive slurry system;
the binder is a resin that is resistant to an electrolyte of a lithium ion battery and a high voltage, the resin is polyacrylic acid (PAA) that has a wide molecular weight distribution and a salt thereof, or a modified acrylic resin, or one of modified polyacrylonitrile (PAN) resins or a mixture thereof, the binder has a solid content of 5 wt % to 30 wt % when dispersed in deionized water, the binder is applicable to an aqueous medium, binds the conductive slurry between a current collector body and a positive or negative electrode material, and further improves a fixing capacity therebetween; and
the solvent is the deionized water.

8. A method for preparing the conductive slurry for preparing the high-performance lithium battery current collector according to claim 6, comprising:
S1, preparing materials: preparing a modified multi-walled carbon nanotube, a nano-conductive agent, a modified nanofiber, a dispersant, a binder and a solvent in proportion;
S2, preparing a high-concentration modified conductive agent suspension: weighing the modified nanofiber and the dispersant in proportion and adding them into ⅓ of the solvent, and completely dissolving the modified nanofiber and the dispersant through mechanical stirring; weighing and adding a modified conductive agent of an amount required into a mixed solution, and performing ultrasonic treatment for 30 min; and obtaining a modified conductive agent suspension, specifically a high-concentration modified multi-walled carbon nanotube suspension;
S3, performing magnetizing: placing the modified conductive agent suspension in a strong external magnetic field for magnetization to further stimulate the magnetic anisotropy of magnetically-modified multi-walled carbon nanotubes to obtain the a high-concentration magnetically-modified multi-walled carbon nanotube suspension;
S4, performing preliminary dispersion: adding a binder in a corresponding proportion to the high-concentration magnetically-modified multi-walled carbon nanotube suspension, supplementing the solvent to a required amount, and performing the preliminary dispersion by sequentially using a high-speed vacuum disperser and a sand mill; wherein the vacuum disperser has a shearing speed of 10 m/s to 25 m/s, a vacuum degree not lower than 0.085 MPa, and vacuum dispersing time of 1 h to 5 h during dispersion, and the sand mill comprises sand mill beads that have a diameter of 0.2 mm to 2 mm and account for 30% to 90%, and has a sand mill speed of 600 r/min to 10000 r/min and sand mill time of is 0.1 h to 5 h; and
S5: performing secondary dispersion: performing the secondary dispersion using an ultrasonic processing apparatus in an ultrasonic resonance manner, applying alternating magnetic fields at two sides to further uniformly disperse the modified multi-walled carbon nanotubes and nano-conductive agent particles and align them in the same direction under induction of the magnetic field, so as to obtain a magnetically-oriented conductive slurry.

9. The method according to claim 8, wherein in S2 and S5, the ultrasonic processing apparatus is an ultrasonic generator placed in a liquid, and each power unit has an ultrasonic frequency of 20 kHz to 40 k Hz, and a power of 1 kW to 3 kW; and in S3 and S5, the alternating magnetic field has an intensity of 0.1 T to 5 T and a frequency is 40 Hz to 60 Hz.

10. A method for preparing the high-performance lithium battery current collector according to claim 1, comprising:
(A1) preparing a metal foil of the current collector and a dispersed conductive slurry, and arranging a coating apparatus, an ultrasonic apparatus, a constant magnetic field generator, and a drying device;
(A2) coating the dispersed conductive slurry on a surface of the metal foil, and forming a liquid colloid coating that has a viscosity of 200 mPa·s to 1000 mPa·s at 25° C. and a thickness of 500 nm to 1200 nm on the surface;
(A3) continuously applying a constant magnetic field that has a direction perpendicular to the surface of the metal foil to the liquid colloid coating, and causing, under induction of the external magnetic field, oriented modified conductive agents in the coating to be orderly arranged, gradually straightened from an original winding state, in a parallel arrangement array, and interwoven with a substrate; and
(A4) drying the coating, evaporating a solvent and a volatile component, continuously applying a constant magnetic field, causing the modified conductive agents to keep an arrangement position and posture, and to be quickly set along with a rapid increase in a viscosity of the coating, and to be arranged obliquely at an angle of 15° to 45° and in parallel in a thickness direction until a solidifiable component of the coating conductive slurry is fixed to the surface of the metal foil, and forms a dense functional covering structure that has a thickness not less than 800 nm, that is, a three-dimensional network connection structure with enhanced fixation, electrical conductivity, thermal conductivity and high reset characteristics is formed on the surface of the metal foil.

11. The method according to claim 10, wherein
step (A3) further comprises:
(A3-1) raising the temperature of the conductive slurry or the coated coating to 45° C. to 65° C. for pre-drying to prolong coagulation time and thereby reducing the viscosity of the liquid colloidal coating, and increasing kinetic energy of the modified conductive agent to untwist, straighten and orientate; and/or further applying ultrasonic waves to the liquid colloid coating to further increase the kinetic energy of the modified conductive agents to untwist, straighten and orientate, accelerate the parallel arrangement array of the modified conductive agents, improve a density of the three-dimensional connection structure formed between the modified conductive agents and the substrate, and thereby forming a three-dimensional network structure with enhanced fixation, electrical conductivity, thermal conductivity, deformation limitation and automatic reset on the surface of the metal foil.

12. A conductive slurry for preparing the high-performance lithium battery current collector according to claim 2, wherein the conductive slurry is an aqueous slurry prepared by dispersing and mixing a modified multi-walled carbon nanotube, a nano-conductive agent, a modified nanofiber, a dispersant, a binder and a solvent, and the slurry has a solid content of 0.1% to 5%, a viscosity of 200 mPa·s to 1000 mPa·s, and a pH of 8 to 11; and
a weight ratio of raw material components of the conductive slurry is as follows: the modified multi-walled carbon nanotube:the nano-conductive agent:the modified nanofiber:the dispersant:the binder:the solvent=(0.01-1.8):(0.01-0.2):(0.02-2):(0.02-20):(0.05-20):(56-99.89).

13. A conductive slurry for preparing the high-performance lithium battery current collector according to claim 3, wherein the conductive slurry is an aqueous slurry prepared by dispersing and mixing a modified multi-walled carbon nanotube, a nano-conductive agent, a modified nanofiber, a dispersant, a binder and a solvent, and the slurry has a solid content of 0.1% to 5%, a viscosity of 200 mPa·s to 1000 mPa·s, and a pH of 8 to 11; and
a weight ratio of raw material components of the conductive slurry is as follows: the modified multi-walled carbon nanotube:the nano-conductive agent:the modified nanofiber:the dispersant:the binder:the solvent=(0.01-1.8):(0.01-0.2):(0.02-2):(0.02-20):(0.05-20):(56-99.89).

14. A conductive slurry for preparing the high-performance lithium battery current collector according to claim 4, wherein the conductive slurry is an aqueous slurry prepared by dispersing and mixing a modified multi-walled carbon nanotube, a nano-conductive agent, a modified nanofiber, a dispersant, a binder and a solvent, and the slurry has a solid content of 0.1% to 5%, a viscosity of 200 mPa·s to 1000 mPa·s, and a pH of 8 to 11; and
a weight ratio of raw material components of the conductive slurry is as follows: the modified multi-walled carbon nanotube:the nano-conductive agent:the modified nanofiber:the dispersant:the binder:the solvent=(0.01-1.8):(0.01-0.2):(0.02-2):(0.02-20):(0.05-20):(56-99.89).

15. A conductive slurry for preparing the high-performance lithium battery current collector according to claim 5, wherein the conductive slurry is an aqueous slurry prepared by dispersing and mixing a modified multi-walled carbon nanotube, a nano-conductive agent, a modified nanofiber, a dispersant, a binder and a solvent, and the slurry has a solid content of 0.1% to 5%, a viscosity of 200 mPa·s to 1000 mPa·s, and a pH of 8 to 11; and
a weight ratio of raw material components of the conductive slurry is as follows: the modified multi-walled carbon nanotube:the nano-conductive agent:the modified nanofiber:the dispersant:the binder:the solvent=(0.01-1.8):(0.01-0.2):(0.02-2):(0.02-20):(0.05-20):(56-99.89).

16. A method for preparing the conductive slurry for preparing the high-performance lithium battery current collector according to claim 7, comprising:
S1, preparing materials: preparing a modified multi-walled carbon nanotube, a nano-conductive agent, a modified nanofiber, a dispersant, a binder and a solvent in proportion;
S2, preparing a high-concentration modified conductive agent suspension: weighing the modified nanofiber and the dispersant in proportion and adding them into ⅓ of the solvent, and completely dissolving the modified nanofiber and the dispersant through mechanical stirring; weighing and adding a modified conductive agent of an amount required into a mixed solution, and performing ultrasonic treatment for 30 min; and obtaining a modified conductive agent suspension, specifically a high-concentration modified multi-walled carbon nanotube suspension;
S3, performing magnetizing: placing the modified conductive agent suspension in a strong external magnetic field for magnetization to further stimulate the magnetic anisotropy of magnetically-modified multi-walled carbon nanotubes to obtain the a high-concentration magnetically-modified multi-walled carbon nanotube suspension;
S4, performing preliminary dispersion: adding a binder in a corresponding proportion to the high-concentration magnetically-modified multi-walled carbon nanotube suspension, supplementing the solvent to a required amount, and performing the preliminary dispersion by sequentially using a high-speed vacuum disperser and a sand mill; wherein the vacuum disperser has a shearing speed of 10 m/s to 25 m/s, a vacuum degree not lower than 0.085 MPa, and vacuum dispersing time of 1 h to 5 h during dispersion, and the sand mill comprises sand mill beads that have a diameter of 0.2 mm to 2 mm and account for 30% to 90%, and has a sand mill speed of 600 r/min to 10000 r/min and sand mill time of is 0.1 h to 5 h; and
S5: performing secondary dispersion: performing the secondary dispersion using an ultrasonic processing apparatus in an ultrasonic resonance manner, applying alternating magnetic fields at two sides to further uniformly disperse the modified multi-walled carbon nanotubes and nano-conductive agent particles and align them in the same direction under induction of the magnetic field, so as to obtain a magnetically-oriented conductive slurry.

17. A method for preparing the high-performance lithium battery current collector according to claim 2, comprising:
(A1) preparing a metal foil of the current collector and a dispersed conductive slurry, and arranging a coating apparatus, an ultrasonic apparatus, a constant magnetic field generator, and a drying device;
(A2) coating the dispersed conductive slurry on a surface of the metal foil, and forming a liquid colloid coating that has a viscosity of 200 mPa·s to 1000 mPa·s at 25° C. and a thickness of 500 nm to 1200 nm on the surface;
(A3) continuously applying a constant magnetic field that has a direction perpendicular to the surface of the metal foil to the liquid colloid coating, and causing, under induction of the external magnetic field, oriented modified conductive agents in the coating to be orderly arranged, gradually straightened from an original winding state, in a parallel arrangement array, and interwoven with a substrate; and
(A4) drying the coating, evaporating a solvent and a volatile component, continuously applying a constant magnetic field, causing the modified conductive agents to keep an arrangement position and posture, and to be quickly set along with a rapid increase in a viscosity of the coating, and to be arranged obliquely at an angle of 15° to 45° and in parallel in a thickness direction until a solidifiable component of the coating conductive slurry is fixed to the surface of the metal foil, and forms a dense functional covering structure that has a thickness not less than 800 nm, that is, a three-dimensional network connection structure with enhanced fixation, electrical conductivity, thermal conductivity and high reset characteristics is formed on the surface of the metal foil.

18. A method for preparing the high-performance lithium battery current collector according to claim 3, comprising:
(A1) preparing a metal foil of the current collector and a dispersed conductive slurry, and arranging a coating apparatus, an ultrasonic apparatus, a constant magnetic field generator, and a drying device;
(A2) coating the dispersed conductive slurry on a surface of the metal foil, and forming a liquid colloid coating that has a viscosity of 200 mPa·s to 1000 mPa·s at 25° C. and a thickness of 500 nm to 1200 nm on the surface;
(A3) continuously applying a constant magnetic field that has a direction perpendicular to the surface of the metal foil to the liquid colloid coating, and causing, under induction of the external magnetic field, oriented modified conductive agents in the coating to be orderly arranged, gradually straightened from an original winding state, in a parallel arrangement array, and interwoven with a substrate; and
(A4) drying the coating, evaporating a solvent and a volatile component, continuously applying a constant magnetic field, causing the modified conductive agents to keep an arrangement position and posture, and to be quickly set along with a rapid increase in a viscosity of the coating, and to be arranged obliquely at an angle of 15° to 45° and in parallel in a thickness direction until a solidifiable component of the coating conductive slurry is fixed to the surface of the metal foil, and forms a dense functional covering structure that has a thickness not less than 800 nm, that is, a three-dimensional network connection structure with enhanced fixation, electrical conductivity, thermal conductivity and high reset characteristics is formed on the surface of the metal foil.

19. A method for preparing the high-performance lithium battery current collector according to claim 4, comprising:
(A1) preparing a metal foil of the current collector and a dispersed conductive slurry, and arranging a coating apparatus, an ultrasonic apparatus, a constant magnetic field generator, and a drying device;
(A2) coating the dispersed conductive slurry on a surface of the metal foil, and forming a liquid colloid coating that has a viscosity of 200 mPa·s to 1000 mPa·s at 25° C. and a thickness of 500 nm to 1200 nm on the surface;
(A3) continuously applying a constant magnetic field that has a direction perpendicular to the surface of the metal foil to the liquid colloid coating, and causing, under induction of the external magnetic field, oriented modified conductive agents in the coating to be orderly arranged, gradually straightened from an original winding state, in a parallel arrangement array, and interwoven with a substrate; and
(A4) drying the coating, evaporating a solvent and a volatile component, continuously applying a constant magnetic field, causing the modified conductive agents to keep an arrangement position and posture, and to be quickly set along with a rapid increase in a viscosity of the coating, and to be arranged obliquely at an angle of 15° to 45° and in parallel in a thickness direction until a solidifiable component of the coating conductive slurry is fixed to the surface of the metal foil, and forms a dense functional covering structure that has a thickness not less than 800 nm, that is, a three-dimensional network connection structure with enhanced fixation, electrical conductivity, thermal conductivity and high reset characteristics is formed on the surface of the metal foil.

20. A method for preparing the high-performance lithium battery current collector according to claim 5, comprising:
(A1) preparing a metal foil of the current collector and a dispersed conductive slurry, and arranging a coating apparatus, an ultrasonic apparatus, a constant magnetic field generator, and a drying device;
(A2) coating the dispersed conductive slurry on a surface of the metal foil, and forming a liquid colloid coating that has a viscosity of 200 mPa·s to 1000 mPa·s at 25° C. and a thickness of 500 nm to 1200 nm on the surface;
(A3) continuously applying a constant magnetic field that has a direction perpendicular to the surface of the metal foil to the liquid colloid coating, and causing, under induction of the external magnetic field, oriented modified conductive agents in the coating to be orderly arranged, gradually straightened from an original winding state, in a parallel arrangement array, and interwoven with a substrate; and
(A4) drying the coating, evaporating a solvent and a volatile component, continuously applying a constant magnetic field, causing the modified conductive agents to keep an arrangement position and posture, and to be quickly set along with a rapid increase in a viscosity of the coating, and to be arranged obliquely at an angle of 15° to 45° and in parallel in a thickness direction until a solidifiable component of the coating conductive slurry is fixed to the surface of the metal foil, and forms a dense functional covering structure that has a thickness not less than 800 nm, that is, a three-dimensional network connection structure with enhanced fixation, electrical conductivity, thermal conductivity and high reset characteristics is formed on the surface of the metal foil.
